(19) United States
(12) Patent Application Publication
(10) Pub. No.: US 2023/0035395 A1
(43) Pub. Date: Feb. 2, 2023

(54) Angled Tissue Box Holder

(71) Applicant: Timothy J. Korytkowski, Sebastian, FL (US)

(72) Inventor: Timothy J. Korytkowski, Sebastian, FL (US)

(21) Appl. No.: 17/963,308

(22) Filed: Oct. 11, 2022

Related U.S. Application Data
(60) Provisional application No. 63/257,810, filed on Oct. 20, 2021.

(51) Int. Cl. F16M 11/24; A47K 10/42

(52) U.S. Cl. CPC F16M 11/24; A47K 10/42

(57) ABSTRACT

An angled tissue box holder with a first panel including a pair of framing tabs defining opposing edges of a panel recess and a midsection aperture. A second panel includes a pair of framing tabs defining opposing edges of a panel recess and a midsection aperture. The first panel is structured to slidably engage the second panel at the respective midsection apertures of each panel to form a pair of angled interior platforms. The pair of angled interior platforms are structured to elevate a tissue box and position it in different tissue distributing orientations.

### FIELD OF THE INVENTION

The present invention relates to systems and methods for positioning a tissue box. In particular, the present invention relates to an angled tissue box holder and associated methods.

### BACKGROUND

In an emerging age of pandemics and new illnesses people have come to reconsider the importance of good hygiene and health preserving practices. Tissues promote good hygiene by helping prevent the spread of germs, bacteria, viruses and disease. Having easy access to tissues therefore furthers that cause.

Tissue boxes pose a unique problem in that they are designed to distribute tissues one after the other when pulled from the box. However, oftentimes when a tissue box has reached its last few tissues, the tissues don't protrude from the box and a user is forced to dig into the tissue box when it rests in its normal orientation. Or, the user is forced to turn the box upside down to have gravity push the remaining tissues toward the distributing surface so the tissues can be easily reached. Either way, this causes unnecessary handling of the tissue box, which in itself may cause the spread of germs.

Therefore, there exists a need to display and orient a tissue box in a manner where touching the box is minimized. Furthermore, there exists a need to orient the box in a manner where the last remaining tissues are forced by gravity to be positioned proximate the tissue box distributing surface and aperture. Hence, there exists a need in the art for an angled tissue box holder.

### SUMMARY OF THE INVENTION

Embodiments of the present invention are related to an angled tissue box holder with a first panel including a pair of framing tabs defining opposing edges of a panel recess and a midsection aperture. A second panel may include a pair of framing tabs defining opposing edges of a panel recess and a midsection aperture. The first panel may be structured to slidably engage the second panel at the respective midsection apertures of each panel to form a pair of angled interior platforms. The pair of angled interior platforms may be structured to elevate a tissue box and position it in different tissue distributing orientations.

In this embodiment, at least one of the first panel recess and second panel recess may be structured to frame a tissue box's dispensing aperture. The panel recesses of the first panel and second panel may be sized to accommodate a tissue passing therethrough. In this embodiment, the first panel and the second panel may be congruent. Furthermore, the respective midsection apertures of the first panel and second panel may each extend from one edge of the respective panel to the middle of the respective panel. The angled interior platforms may be structured to position and hold a tissue box distributing surface at a 45-degree angle.

The panel recess of at least one of the first panel and second panel may be sized to frame the longitudinal length of a standard rectangular prism shaped tissue box dispensing aperture therein. Additionally, the first panel and second panel may be structured to form a removably engageable x-shaped apparatus. The upper v created by the x-shape forms a pair of angled holding platforms and the lower inverted v created by the x-shape forms a pair of legs.

Another embodiment of the invention may include an angled tissue box holder with a larger first panel including a pair of framing tabs defining opposing edges of a larger panel recess and a midsection aperture. A smaller second panel may include a pair of framing tabs defining opposing edges of a smaller panel recess with a midsection aperture. The larger first panel may be structured to slidably engage the smaller second panel at the respective midsection apertures of each panel to form a pair of angled interior platforms. Furthermore, the pair of angled interior platforms may be structured to accommodate a plurality of differently sized tissue boxes for positioning in different tissue distributing orientations.

In this embodiment, the panel recess of the first larger panel may be sized to frame the longitudinal length of a standard rectangular prism shaped tissue box dispensing aperture therein. Likewise, the panel recess of the second smaller panel may be sized to frame the longitudinal length of a standard cube shaped tissue box dispensing aperture therein. Each respective panel may include removably attached foot clips to stabilize the angled tissue box holder and the vertices of each panel may be rounded.

In this embodiment, the smaller second panel may be structured to be centered within the larger first panel when the two panels are removably engaged. The smaller second panel may have a width that is 50% smaller than the longitudinal width of the larger first panel. However, the smaller second panel may include a height from bottom edge to framing tab top that measures the same as the bottom edge to framing tab top of the larger first panel.

In this embodiment the first panel and second panel may also be structured to form a removably engageable x-shaped apparatus. The upper v created by the x-shape may form a pair of angled holding platforms and the lower inverted v created by the x-shape may form a pair of legs.

### BRIEF DESCRIPTION OF THE DRAWINGS

FIG. 1 is a top perspective view of an angled tissue box holder according to an embodiment of the invention.

FIG. 2 is a top longitudinal view of the angled tissue box holder illustrated in FIG. 1.

FIG. 3A is a front perspective environmental view of the angled tissue box holder illustrated in FIG. 1 with a tissue box in a first position.

FIG. 3B is a side perspective environmental view of the angled tissue box holder illustrated in FIG. 1 with a tissue box in a first position.

FIG. 4A is a front perspective environmental view of the angled tissue box holder illustrated in FIG. 1 with a tissue box in a second position.

FIG. 4B is a side perspective environmental view of the angled tissue box holder illustrated in FIG. 1 with a tissue box in a second position.

FIG. 5 is a perspective view of a panel component of the angled tissue box holder illustrated in FIG. 1.

FIG. 6A is a perspective view of two panel components of the angled tissue box holder illustrated in FIG. 1.

FIG. 6B is a perspective view of two panel components of the angled tissue box holder illustrated in FIG. 1 being fitted together.

FIG. 6C is a perspective view of two panel components of the angled tissue box holder illustrated in FIG. 1 being fitted together.

FIG. 7 is a top perspective view of another embodiment of the angled tissue box holder.

FIG. 8 is a top perspective view of the angled tissue box holder illustrated in FIG. 7.

FIG. 9A is a is an environmental side perspective view of the angled tissue box holder illustrated in FIG. 7.

FIG. 9B is an environmental back view of the angled tissue box holder illustrated in FIG. 9A.

FIG. 9C is an environmental front view of the angled tissue box holder illustrated in FIG. 9A.

FIG. 10A is an environmental side perspective view of the angled tissue box holder illustrated in FIG. 7.

FIG. 10B is an environmental front view of the angled tissue box holder illustrated in FIG. 10A.

FIG. 10C is an environmental back view of the angled tissue box holder illustrated in FIG. 10A.

FIG. 11A is an environmental side perspective view of the angled tissue box holder illustrated in FIG. 7.

FIG. 11B is an environmental back view of the angled tissue box holder illustrated in FIG. 11A.

FIG. 11C is an environmental front view of the angled tissue box holder illustrated in FIG. 11A.

FIG. 12A is an environmental side perspective view of the angled tissue box holder illustrated in FIG. 7.

FIG. 12B is an environmental front view of the angled tissue box holder illustrated in FIG. 12A.

FIG. 12C is an environmental back view of the angled tissue box holder illustrated in FIG. 12A.

FIG. 13 is a perspective view of two panel components of the angled tissue box holder embodiment illustrated in FIG. 7.

FIG. 14 is a perspective view of two panel components of the angled tissue box holder embodiment illustrated in FIG. 7 being fitted together.

FIG. 15 is a perspective view of two panel components of the angled tissue box holder embodiment illustrated in FIG. 7 fitted together.

FIG. 16 is a perspective view of foot clip components of the angled tissue box holder according to an embodiment of the invention.

### DETAILED DESCRIPTION OF THE INVENTION

The present invention will now be described in detail with reference to the accompanying drawings. The embodiment descriptions are illustrative and not intended to be limiting in any way. Other embodiments of the invention will readily suggest themselves to persons with ordinary skill in the art after having the benefit of this disclosure. Accordingly, the following embodiments are set forth without any loss of generality and without imposing limitation upon the claimed invention.

Directional terms such as “above” “below” “upper” “lower” and other like terms are used for the convenience of the reader in reference to the drawings. Additionally, the description may contain terminology to convey position, orientation, and direction without departing from the principles of the present invention. Such positional language should be taken in context of the represented drawings.

Quantitative terms such as “generally” “substantially” “mostly” and other like terms are used to mean that the referred object, characteristic, or quality constitutes a majority of the referenced subject. Likewise, use of the terms such as first and second do not necessarily designate a limitation of quantity. Such terms may be used as a method of describing the presence of at least one of the referenced elements or may provide a means of differentiating orientation. The meaning of any term within this description is dependent upon the context within which it is used, and the meaning may be expressly modified.

Described in more detail hereinafter is an angled tissue box holder with a pair of angled interior platforms and respective recesses structured to elevate a tissue box and position it in different tissue distributing orientations.

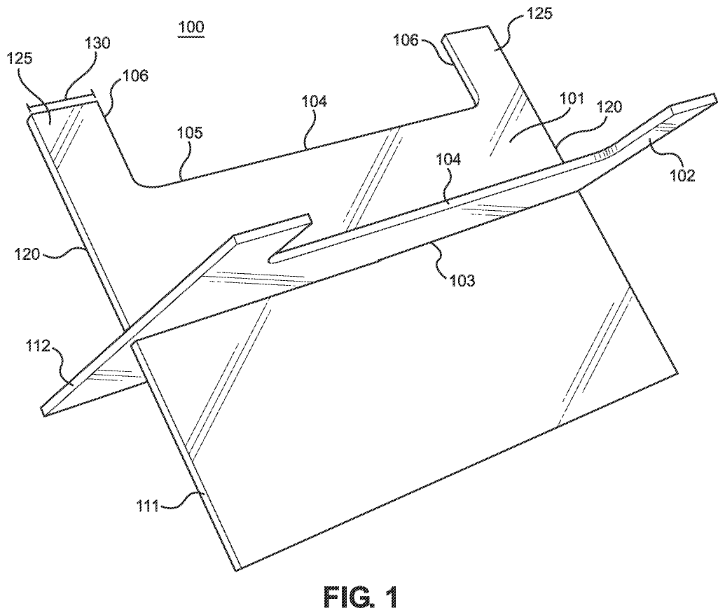

Referring now to FIG. 1, an angled tissue box holder 100, hereinafter referred to as the apparatus 100, may include a first panel 101 and a second panel 102 removably fitted together at a bifurcating midsection 103. Both the first and second panels 101, 102 may include a panel recess 104 with opposing recess sides 106 and a recess longitudinal edge 105. The panel recess 104 may resemble a rectangular notch on the interior upper portion of each respective panel 101, 102. The recess sides 106 may be positioned at a measured distance 130 away from each respective panel edge 120. This measured distance 130 may create framing tabs 125 at upper ends of the respective panels 101, 102. The framing tabs 125 may include a width the size of the measured distance 130 and may include a height the size of the recess sides 106. The framing tabs 125 may define opposing edges of the panel recess 104 and may be sized to accommodate a tissue passing therethrough. Similarly, at least one of the panels 101, 102 may be sized to frame the longitudinal length of a standard rectangular prism shaped tissue box dispensing aperture therein.

By way of non-limiting example, the measured distance may be 1 inch, the recess sides may be 1¼ inches, and the recess longitudinal edge may be 7½ inches. Likewise, the longitudinal measurement of each respective panel 101, 102 may be 9 inches. However, one skilled in the art will appreciate that the measurements may be larger or smaller depending on need, preference, and circumstance.

The panels 101, 102 may be intersected with each other at the bifurcating midsection 103 to form a removably engageable crisscrossed structure and an x-shaped apparatus 100. Hence, the lower portion of the apparatus 100 includes a first panel leg 111 and a second panel leg 112 forming the lower half of the ‘X’. In other words, the v created by the x-shape forms a pair of angled holding platforms and the lower inverted v created by the x-shape forms a pair of legs.

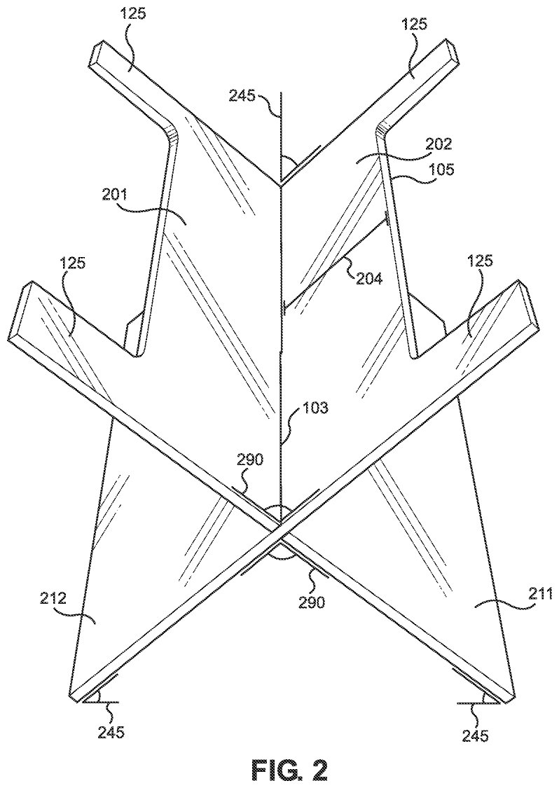

FIG. 2 provides a top-down longitudinal view of the apparatus 100 illustrating a first panel holding surface 201 and a second panel holding surface 202. These holding surfaces 201, 202 may be used to support the majority of the surface area of one side of a tissue box. The holding surfaces 201, 202 may include the holding surface body 204 with a lateral distance running from the bifurcating midsection 103 to the recess longitudinal edge 105. The framing tabs 125 on either end of the holding surfaces 201, 202 may also help to support some of the surface area of a tissue box.

Because the apparatus 100 includes an ‘X’ shaped body, the upper portion of the apparatus 100 above the bifurcating midsection 103 includes the interior upper surfaces of the first panel 101 and second panel 102 opposing each other at approximately a 90-degree angle 290. As such, the panel legs 211, 212 may be splayed from each other at a 90-degree angle 290 below the bifurcating midsection 103. This results in the first panel leg 211 and the second panel leg 212 sitting at approximately 45-degree angles 245 relative to horizontal. This also means that the holding surfaces 201, 202 may be positioned at approximately 45-degree angles 245 relative to perpendicular. However, one skilled in the art will appreciate that these angles may be larger or smaller depending on need, preference, and circumstance.

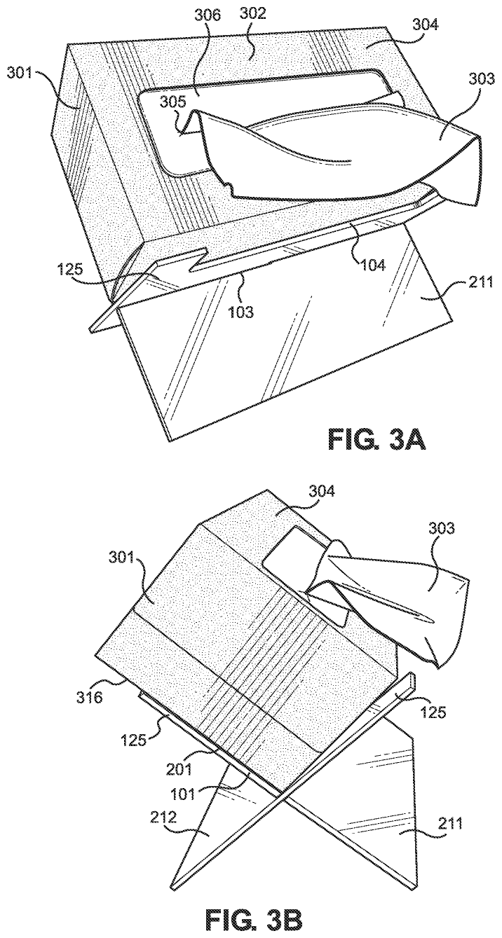

FIGS. 3A and 3B illustrate the apparatus 100 holding a tissue box 302 in a first position 301, defined as a back position 301. As illustrated, the tissue box bottom 316 is resting against the first panel holding surface 201 and the first panel framing tabs 125. As a result, the tissue box dispensing surface 304 is tilted upward relative to horizontal so that the tissue box dispensing aperture 305 is dispensing tissues 303 at an upward angle above the bifurcating midsection 103. In fact, because the interior upper surfaces of the first panel 101 and second panel 102 form approximately a 90-degree angle, placing the tissue box 302 in the back position allows the 90-degree angle of at least two surfaces of the tissue box to conform in position with the first and second panel holding surfaces 201, 202. As shown, the first and second panel legs 211, 212 are supporting the apparatus 100 at its base below the bifurcating midsection 103. Meanwhile, the upper portion of the apparatus 100 above the bifurcating midsection 103 is supporting the tissue box 302 for dispensing tissues 303.

As further illustrated in these figures, the framing tabs 125 serve to frame the dispensing window 306 and the dispensing aperture 305 that distributes the tissues 303. Not only does this provide an aesthetic symmetry between the apparatus 100 and the tissue box 302, but it also facilitates a user's ability to center a tissue box 302 on the apparatus 100 and facilitates a user's ability to remove a tissue 303 without interference from either of the panels 111, 112.

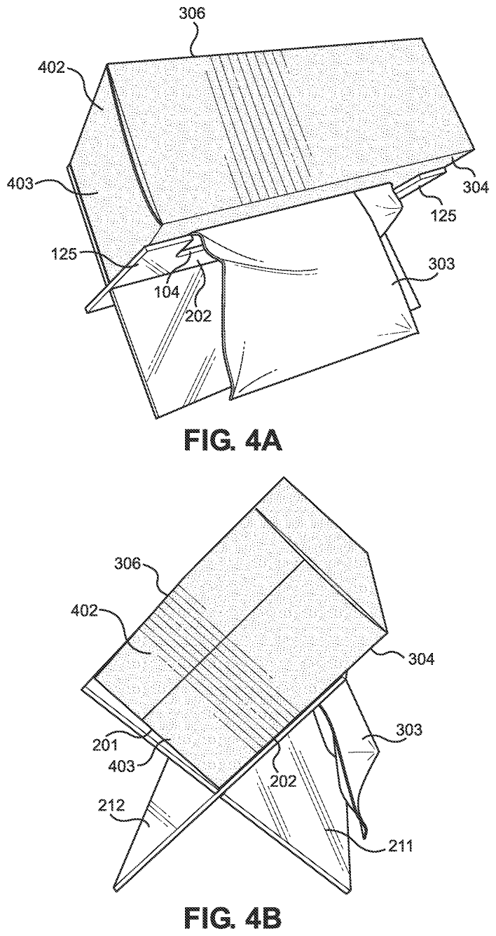

FIGS. 4A and 4B illustrate the apparatus 100 holding a tissue box 302 in a second position 402, defined as a front position 402. As illustrated, the tissue box dispensing surface 304 is resting against the second panel holding surface 201 and the second panel framing tabs 125. As a result, the tissue box dispensing surface 304 is tilted downward relative to horizontal so that the tissue box dispensing aperture 305 is dispensing tissues 303 at a downward angle between the two framing tabs 125. Therefore, in this position the tissue box bottom 316 is inverted to face upward and the tissue box dispensing surface 304 is inverted to face downward at 45-degree angles 245 respectively. The panel recess 104 of at least one panel 101, 102 is structured to frame the tissue box dispensing aperture 305.

Because the interior upper surfaces of the first panel 101 and second panel 102 form approximately a 90-degree angle, placing the tissue box 302 in the front position allows the 90-degree angle of at least two surfaces of the tissue box 302, namely the dispensing surface 304 and a side surface 403, to conform in position with the first and second panel holding surfaces 201, 202. It also allows may allow the interior platforms to position and hold a tissue box distributing surface at a 45-degree angle. When in the front position 402 the first and second panel legs 211, 212 are supporting the apparatus 100 at its base below the bifurcating midsection 103. Meanwhile, the upper portion of the apparatus 100 above the bifurcating midsection 103 is supporting the tissue box 302 for dispensing tissues 303.

Placing the tissue box 303 in the front position 402 allows for a user to easily pull down on a tissue 303 to remove it from the tissue box 302. More importantly, placing the tissue box 302 in the front position 402 allows for gravity to force the reserve tissues 303 in the tissue box 302 to press against the tissue box dispensing surface 304. This means that when the reserve tissues 303 have retreated into the tissue box 302 due to a dwindling supply or simply a user mishap, the tissues are easily retrievable without a user having to reach deep into the dispensing aperture 305.

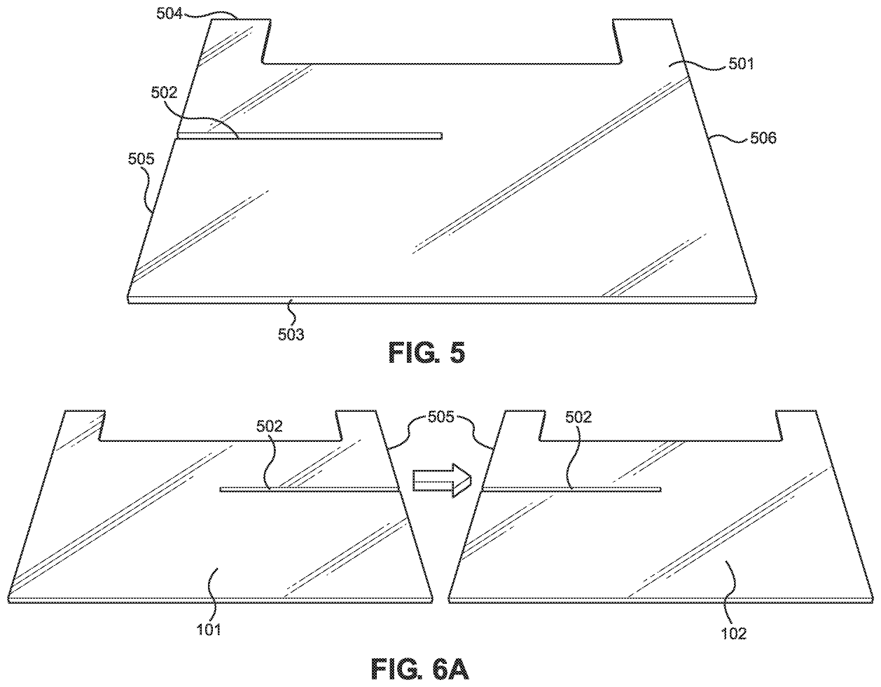

FIG. 5 illustrates a single panel 501, which is the main component of the apparatus 100. The apparatus 100 consists of two panels 501 each with a midsection aperture 502 approximately 50-50% the distance between the panel bottom edge 503 and the framing tab top edge 504. Furthermore, each midsection aperture 502 may extend approximately 55% the longitudinal length of each respective panel 501 spanning from an attachment edge 505 to an opposing edge 506. However, one skilled in the art will appreciate that the length and measurements of the single panel 501 along with its midsection aperture 502 may be larger or smaller depending on need, preference, and circumstance. Furthermore, by way of non-limiting example, the single panel 501 may be made of plastic, plexiglass, glass, wood, or the like.

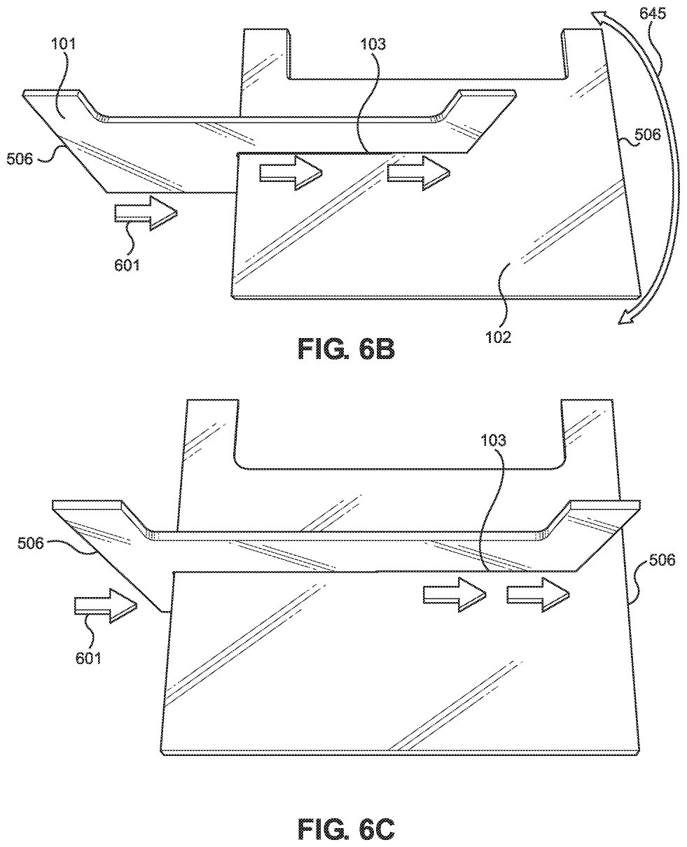

FIGS. 6A, 6B, and 6C all demonstrate assembly of the apparatus 100 utilizing two panels 501. As shown in FIG. 6A, the first panel 101 and second panel 102 may removably and slidably engage each other at their respective attachment edge 505 midsection apertures 502 to form a pair of angled interior platforms. The midsection apertures 502 may extend from one edge of the respective panel to the middle of that respective panel.

FIG. 6B illustrates that the second panel 102 may be rotated approximately 45-degrees clockwise and the first panel 101 may be rotated approximately 45-degrees counterclockwise to engage each other along their respective midsection apertures 502. As shown, a user may apply longitudinal force 601 to the first panel 101 to slidably translate the first panel 101 into the second panel 102 to create the bifurcating midsection 103. The longitudinal force 601 is applied in this manner until the opposing edge 506 of the second panel 102 is flush with the attachment edge 505 of the first panel 101. Likewise, the longitudinal force 601 may be applied until the opposing edge 506 of the first panel 101 is flush with the attachment edge 505 of the second panel 102.

One skilled in the art will appreciate that the use of a single panel 501 in production and two congruent panels 501 for assembly facilitates easy manufacturing without the need for any moving parts or attachment members such as screws or adhesives. Furthermore, since both panels 101, 102 are made from the same single panel 501, they may be constructed, packaged, and shipped in an expedited and cost-efficient manner. Likewise, the modular aspect of the apparatus 100 adds to its durability, repairability, and single component replaceability.

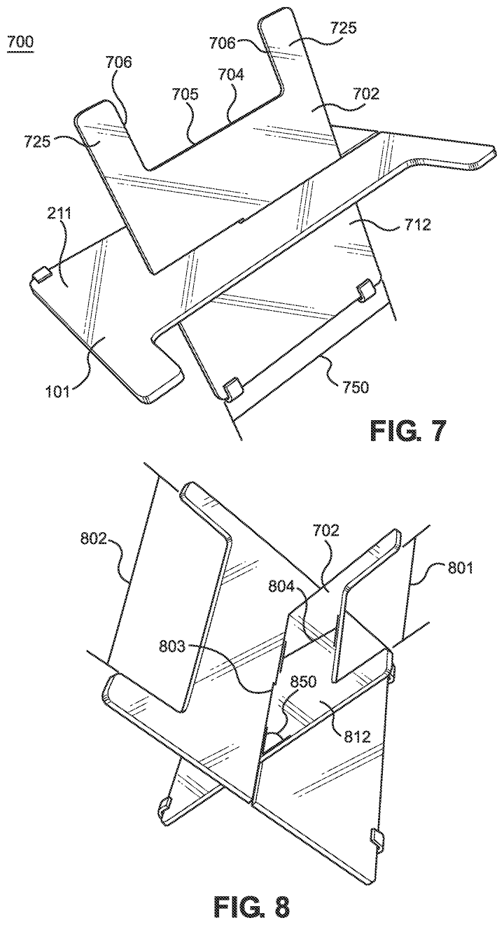

FIGS. 7 through 15 describe a second embodiment of the apparatus 700 structured to accommodate both an elongate rectangular prism style tissue box as well as a cube shaped style tissue box. Like the first embodiment 100, the panels 101, 702 may slidably engage at their respective midsection apertures to form a pair of angled interior platforms. However, in this embodiment, the panels 101, 702 may be structured to accommodate a plurality of differently sized tissue boxes for positioning in different tissue distributing orientations.

Similar to the previous embodiment, the panels 101, 702 may be intersected with each other at the bifurcating midsection 803 to form a removably engageable crisscrossed structure and an x-shaped apparatus 700. Hence, the lower portion of the apparatus 700 includes a first panel leg 111 and a second panel leg 712 forming the lower half of the ‘X’. In other words, the v created by the x-shape forms a pair of angled holding platforms and the lower inverted v created by the x-shape forms a pair of legs.

FIG. 7 illustrates the apparatus 100 as having a first panel 101 and a second panel 702. The first panel 101 may be the same style and dimensions as in the previous apparatus embodiment 100. However, in this second embodiment, the first panel 101 may be considered the larger first panel and the second panel 702 may be considered the smaller second panel 702.

The second panel 702 may include a pair of framing tabs 725 defining opposing edges of a second panel recess 704 and may be structured to frame a tissue box dispensing aperture. The framing tabs 725 may include recess sides 706 that form the outer edges of the panel recess 704 defining its size. Likewise, a recess longitudinal edge 705 may further define the size of the second panel recess 704 structuring it to frame a cube shaped tissue box dispensing aperture.

The second panel 702 recess longitudinal edge 705 may measure smaller than the recess longitudinal edge 105 of the first panel. In some embodiments, it may measure 50% smaller. Likewise, in some embodiments, the second panel width 750 may measure 50% smaller than the longitudinal width of the larger first panel 101. As such, when assembled the second panel leg 712 may be positioned centrally when compared to the first panel leg 211. However, one skilled in the art will appreciate that the size ratio between the smaller second panel 702 and the larger first panel 101 may be greater or less depending on need, preference, and circumstance.

FIG. 8 shows a comparison between the second panel recess 801 and the first panel recess length 802. This figure also depicts the second panel holding surface 812 and shows that the holding surface body lateral distance 804 may be the same in the second panel 702 as it is in the first panel 101. Furthermore, the upper angle created between the first and second panels 101, 702 at the bifurcating midsection 803 may be 90 degrees 850. This may allow for the interior platforms to position and hold a tissue box distributing surface at a 45-degree angle.

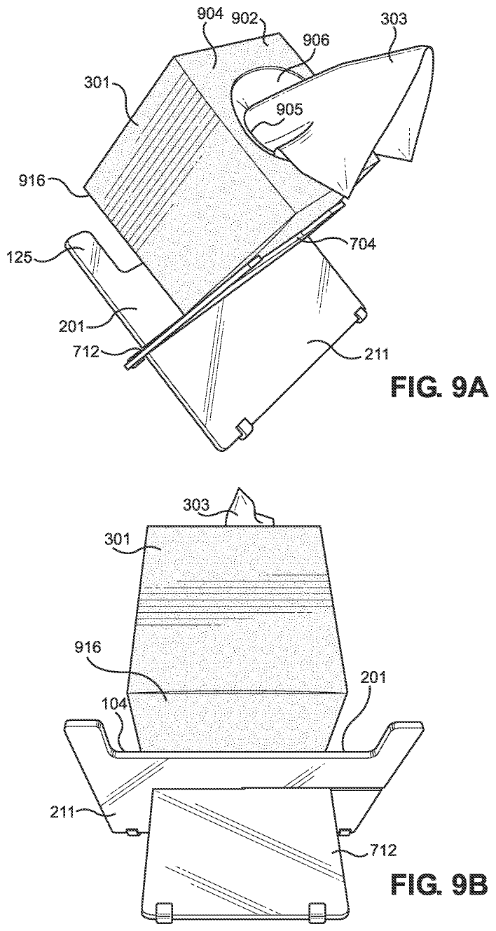

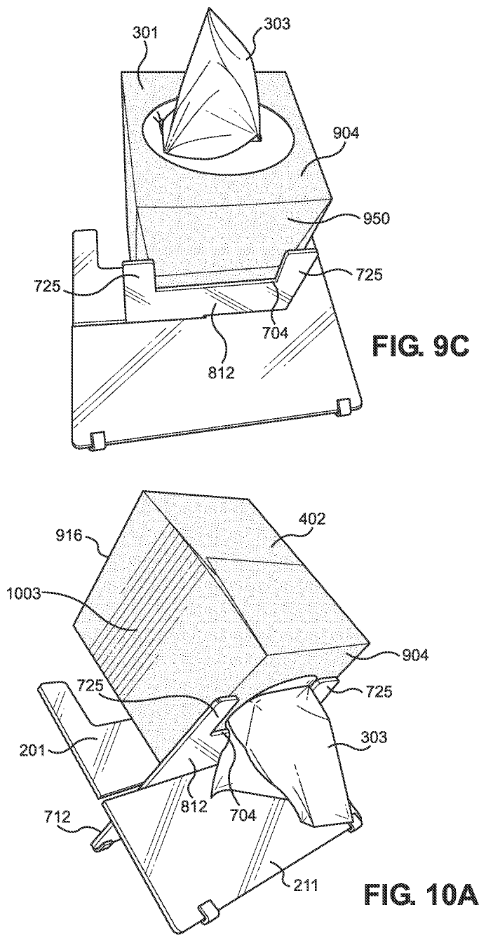

FIGS. 9A through 9C illustrate environmental views of the apparatus 700 whereby a standard cube shaped tissue box 902 is resting in a first position 301, also defined as a back position 301. As illustrated, the tissue box bottom 916 is resting against the first panel holding surface 201 and the first panel framing tabs 125. As a result, the tissue box dispensing surface 904 is tilted upward relative to horizontal so that the tissue box dispensing aperture 905 is dispensing tissues 303 at an upward angle above the bifurcating midsection 103. In fact, because the interior upper surfaces of the first panel 101 and second panel 702 form approximately a 90-degree angle, placing the tissue box 302 in the back position allows the 90-degree angle of at least two surfaces of the tissue box to conform in position with the first and second panel holding surfaces 201, 812. As shown, the first and second panel legs 211, 712 are supporting the apparatus 100 at its base below the bifurcating midsection 803. Meanwhile, the upper portion of the apparatus 100 above the bifurcating midsection 803 is supporting the tissue box 902 for dispensing tissues 303.

As further illustrated in these figures, the framing tabs 725 serve to center the dispensing window 906 and the dispensing aperture 905 that distributes the tissues 303. Not only does this provide an aesthetic symmetry between the apparatus 100 and the tissue box 902, but it also facilitates a user's ability to center a tissue box 302 on the apparatus 100.

FIG. 9B illustrates an environmental view of the cube shaped tissue box 902 from the backside while being held by the apparatus 700. As shown, the tissue box bottom 916 may be centered between the first panel framing tabs 125 while it rests on the first panel holding surface body 201.

FIG. 9C illustrates an environmental view of the cube shaped tissue box 902 from the frontside while being held by the apparatus 700. As shown, the tissue box side surface 950 is supported by and between the two framing tabs 725 as well as the second panel holding surface 812. The tissue box dispensing surface 904 in this position allows a user to grab a tissue 303 without interference from either panel 101, 702.

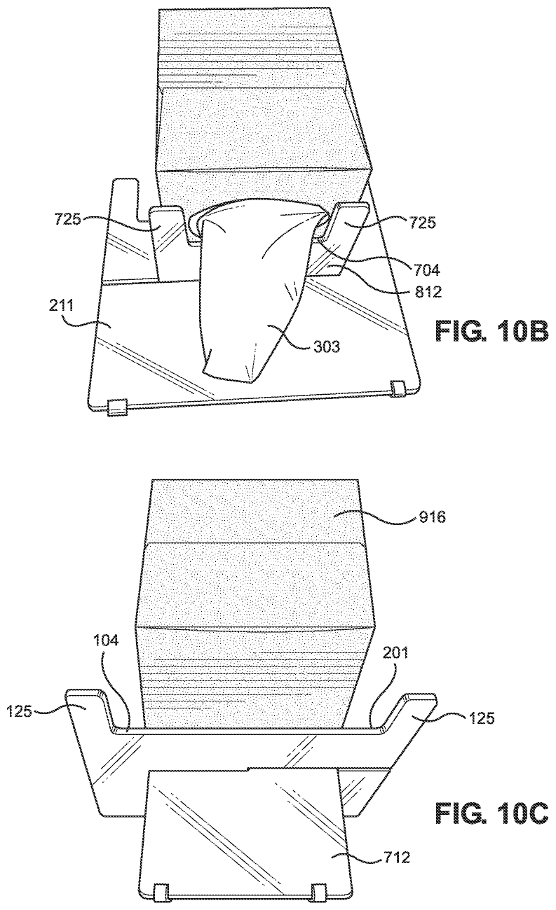

FIG. 10A through 10C illustrate the apparatus 100 holding a tissue box 902 in a second position 402, defined as a front position 402. As illustrated, the tissue box dispensing surface 304 is resting against the second panel holding surface 812 and the second panel framing tabs 725. As a result, the tissue box dispensing surface 904 is tilted downward relative to horizontal so that the tissue box dispensing aperture 905 is dispensing tissues 303 at a downward angle between the two framing tabs 725. Therefore, in this position the tissue box bottom 916 is inverted to face upward and the tissue box dispensing surface 904 is inverted to face downward at 45-degree angles respectively.

Because the interior upper surfaces of the first panel 101 and second panel 702 form approximately a 90-degree angle, placing the cube shaped tissue box 902 in the front position allows the 90-degree angle of at least two surfaces of the tissue box, namely the dispensing surface 904 and a side surface 1003, to conform in position with the first and second panel holding surfaces 201, 812. When in the front position 402 the first and second panel legs 211,712 are supporting the apparatus 700 at its base below the bifurcating midsection 803. Meanwhile, the upper portion of the apparatus 100 above the bifurcating midsection 803 is supporting the cubed shaped tissue box 902 for dispensing tissues 303.

Placing the tissue box 303 in the front position 402 allows for a user to easily pull down on a tissue 303 to remove it from the tissue box 902. More importantly, placing the tissue box 902 in the front position 402 allows for gravity to force the reserve tissues 303 in the tissue box 902 to press against the tissue box dispensing surface 904. This means that when the reserve tissues 303 have retreated into the tissue box 902 due to a dwindling supply or simply a user mishap, the tissues 303 are easily retrievable without a user having to reach deep into the dispensing aperture 905.

FIG. 10B illustrates how the front position 402 allows for the second panel framing tabs 725 to frame the longitudinal length of a standard cube shaped tissue box dispensing aperture 905 therein. This allows for the tissues to easily be retrieved by a user since they are already oriented downwards.

FIG. 10C is a back view of the apparatus 700 in a front position and illustrates that the cube shaped tissue box 902 may be centered between the first panel framing tabs 125 and the first panel recess 904. It is also resting against the second panel holding surface 812.

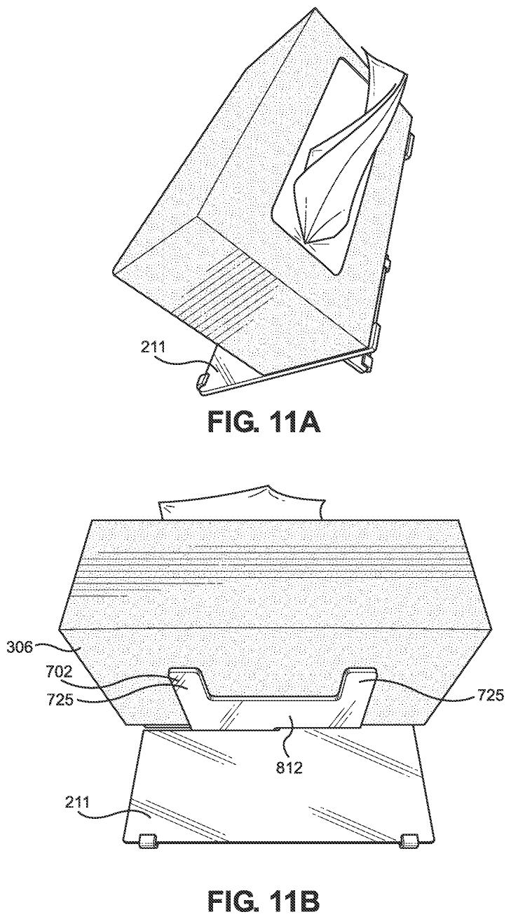

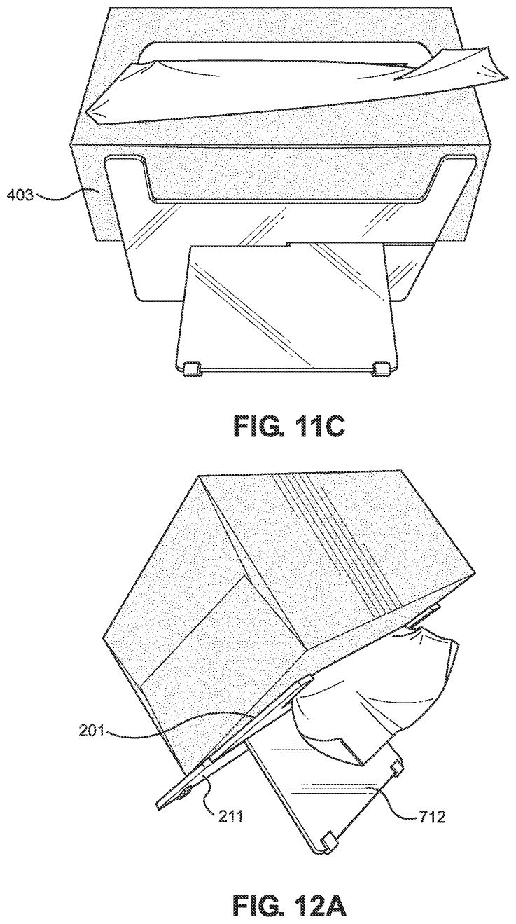

FIGS. 11A through 11C illustrate an environmental view of the apparatus 700 displaying a standard rectangular prism shaped tissue box 302 in a back position 301. In many respects, the apparatus 700 shares the same features as the previous embodiment 100 regarding this sized tissue box 302. As illustrated, the tissue box bottom 316 is resting against the first panel holding surface 201 and the first panel framing tabs 125. As a result, the tissue box dispensing surface 304 is tilted upward relative to horizontal so that the tissue box dispensing aperture 305 is dispensing tissues 303 at an upward angle above the bifurcating midsection 103. In fact, because the interior upper surfaces of the first panel 101 and second panel 102 form approximately a 90-degree angle, placing the tissue box 302 in the back position allows the 90-degree angle of at least two surfaces of the tissue box to conform in position with the first and second panel holding surfaces 201, 702. As shown, the first and second panel legs 211, 712 are supporting the apparatus 700 at its base below the bifurcating midsection 803. Meanwhile, the upper portion of the apparatus 700 above the bifurcating midsection 803 is supporting the tissue box 302 for dispensing tissues 303.

The main difference in this embodiment 700 versus the previous embodiment 100 in the back position 301 is the fact that the second panel framing tabs 725 are centered along the rectangular prism shaped tissue box 302 since the second panel 702 is smaller in width than in the previous embodiment 100. As shown by FIG. 11B, the second panel framing tabs 725 are centrally supporting the tissue box bottom 306 while the second panel 702 itself is centrally positioned with regards to the first panel 101.

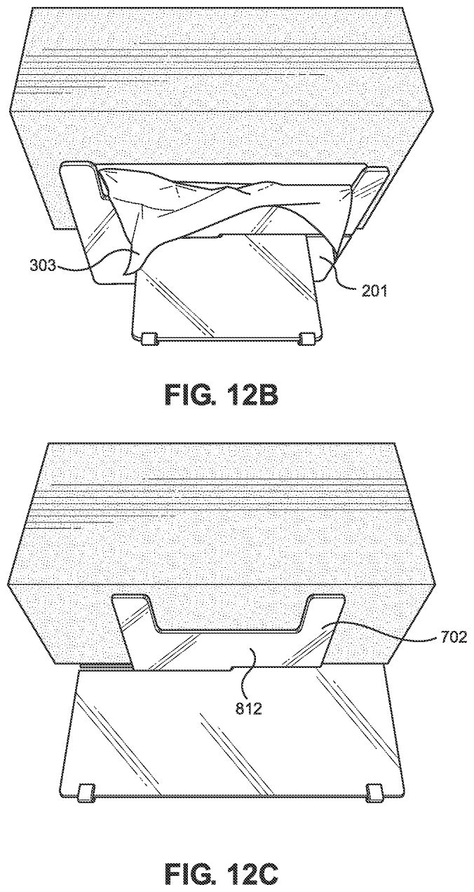

FIGS. 12A through 12C illustrate an environmental view of the apparatus 700 displaying a standard rectangular prism shaped tissue box 302 in a front position 402. Again, the functionality of the second embodiment 700 in the front position 402 is the same as that of the first embodiment 100. However, due to the reduced size of the second panel 702, its framing tabs 725 and second panel holding surface 812 are centered and supporting it along a back side panel of the tissue box 302.

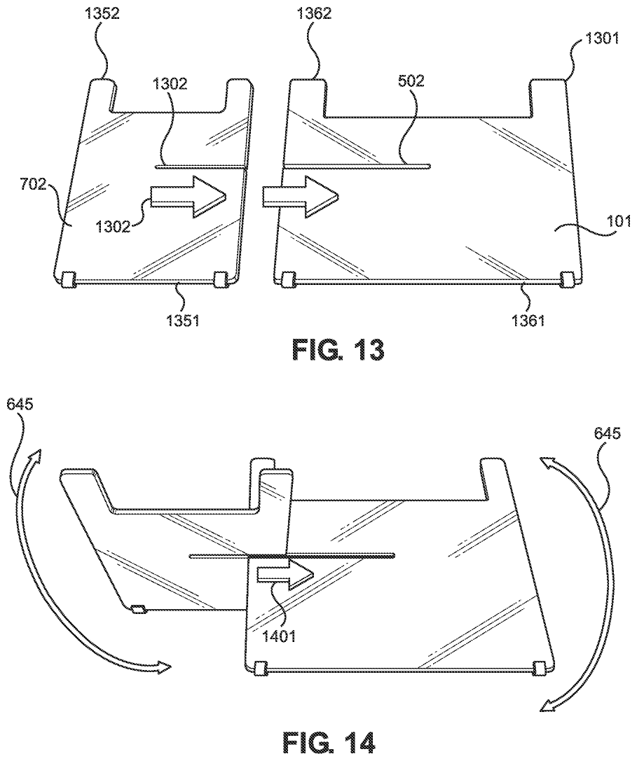

FIGS. 13 through 15 illustrate how the second embodiment 700 may fit together. Furthermore, FIG. 13 illustrates a good size comparison between the first panel 101 and the second panel 702. As shown, the smaller second panel 702 may include a width that is 50% smaller than the longitudinal width of the larger first panel 101. However, the smaller second panel 702 may include a height from its bottom edge 1351 to framing tab top 1351 that measures the same as the bottom edge 1361 to framing tab top 1362 of the larger first panel 101. Furthermore, the panel recesses 104, 704 are shown as having the same depth, but the second panel recess 704 has a longitudinal width 801 that may be 50% smaller than the larger first panel 802. Also shown is that the vertices of either embodiment 100, 700 may be rounded 1301.

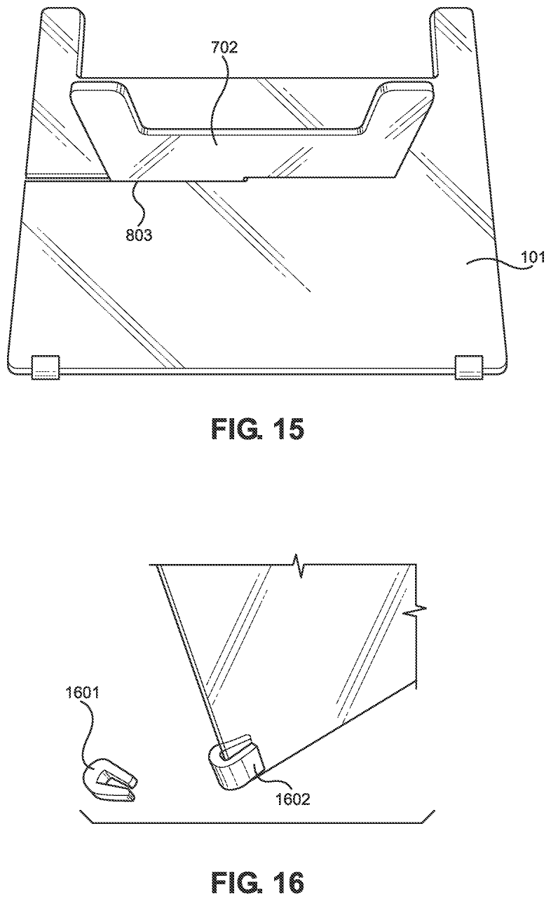

Referring additionally to FIGS. 14 and 15, similar to the previous embodiment 100, the second embodiment 700 may be assembled whereby the first panel 101 and the second panel 702 slidably engage at their respective midsection apertures 502, 1302. Also illustrated is that the second panel 702 may be rotated approximately 45-degrees clockwise and the first panel 101 may be rotated approximately 45-degrees counterclockwise to engage each other along their respective midsection apertures 1302, 502. As shown, a user may apply longitudinal force 1302 to the first panel 101 to slidably translate the first panel 101 into the second panel 702 to create the bifurcating midsection 103. The longitudinal force 1302 is applied in this manner until the second panel 702 is centered within the first panel 101.

FIG. 16 illustrates that either apparatus embodiment 100, 700 may include removably attached foot clips 1601 on the panels 101, 702 to stabilize. The foot clips 1601 may be c-shaped and biased toward being closed so that they may friction fit 1602 onto the edges of the apparatus 100, 700.

That which is claimed is:

1. An angled tissue box holder comprising
a first panel comprising
a pair of framing tabs defining opposing edges of a panel recess,
a midsection aperture,
a second panel comprising
a pair of framing tabs defining opposing edges of a panel recess,
a midsection aperture,
wherein the first panel is configured to slidably engage the second panel at the respective midsection apertures of each panel to form a pair of angled interior platforms; and
wherein the pair of angled interior platforms are configured to elevate a tissue box and position it in different tissue distributing orientations.

2. The angled tissue box holder of claim 1 wherein at least one of the first panel recess and second panel recess are configured to frame a tissue box's dispensing aperture.

3. The angled tissue box holder of claim 1 wherein the panel recesses of the first panel and second panel are sized to accommodate a tissue passing therethrough.

4. The angled tissue box holder of claim 1 wherein the first panel and the second panel are congruent.

5. The angled tissue box holder of claim 1 wherein the respective midsection apertures of the first panel and second panel each extend from one edge of the respective panel to the middle of the respective panel.

6. The angled tissue box holder of claim 1 wherein the angled interior platforms are configured to position and hold a tissue box distributing surface at a 45-degree angle.

7. The angled tissue box holder of claim 1 wherein the panel recess of at least one of the first panel and second panel is sized to frame the longitudinal length of a standard rectangular prism shaped tissue box dispensing aperture therein.

8. The angled tissue box holder of claim 1 wherein the first panel and second panel are configured to form a removably engageable x-shaped apparatus.

9. The angled tissue box holder of claim 8 wherein the upper v created by the x-shape forms a pair of angled holding platforms; and wherein the lower inverted v created by the x-shape forms a pair of legs.

10. An angled tissue box holder comprising
a larger first panel comprising
a pair of framing tabs defining opposing edges of a larger panel recess,
a midsection aperture,
a smaller second panel comprising
a pair of framing tabs defining opposing edges of a smaller panel recess,
a midsection aperture,
wherein the larger first panel is configured to slidably engage the smaller second panel at the respective midsection apertures of each panel to form a pair of angled interior platforms; and
wherein the pair of angled interior platforms are configured to accommodate a plurality of differently sized tissue boxes for positioning in different tissue distributing orientations.

11. The angled tissue box holder of claim 10 wherein the panel recess of the first larger panel is sized to frame the longitudinal length of a standard rectangular prism shaped tissue box dispensing aperture therein.

12. The angled tissue box holder of claim 10 wherein the panel recess of the second smaller panel is sized to frame the longitudinal length of a standard cube shaped tissue box dispensing aperture therein.

13. The angled tissue box holder of claim 10 wherein each respective panel includes removably attached foot clips to stabilize the angled tissue box holder.

14. The angled tissue box holder of claim 10 wherein the vertices of each panel are rounded.

15. The angled tissue box holder of claim 10 wherein the smaller second panel is configured to be centered within the larger first panel when the two panels are removably engaged.

16. The angled tissue box holder of claim 10 wherein the smaller second panel comprises a width that is 50% smaller than the longitudinal width of the larger first panel.

17. The angled tissue box holder of claim 10 wherein the smaller second panel includes a height from bottom edge to framing tab top that measures the same as the bottom edge to framing tab top of the larger first panel.

18. An angled tissue box holder comprising
a larger first panel comprising
a pair of framing tabs defining opposing edges of a larger panel recess,
a midsection aperture,
a smaller second panel comprising
a pair of framing tabs defining opposing edges of a smaller panel recess,
a midsection aperture,
wherein the larger first panel is configured to slidably engage the smaller second panel at the respective midsection apertures of each panel to form a pair of angled interior platforms;
wherein the first panel and second panel are configured to form a removably engageable x-shaped apparatus;
wherein the upper v created by the x-shape forms a pair of angled holding platforms;
wherein the lower inverted v created by the x-shape forms a pair of legs;
wherein the panel recess of the first larger panel is sized to frame the longitudinal length of a standard rectangular prism shaped tissue box dispensing aperture therein; and
wherein the panel recess of the second smaller panel is sized to frame the longitudinal length of a standard cube shaped tissue box dispensing aperture therein.

19. The angled tissue box holder of claim 18 wherein the smaller second panel comprises a width that is 50% smaller than the longitudinal width of the larger first panel; and wherein the smaller second panel includes a height from bottom edge to framing tab top that measures the same as the bottom edge to framing tab top of the larger first panel.

20. The angled tissue box holder of claim 18 wherein the vertices of each panel are rounded.
